(19) United States
(12) Patent Application Publication
(10) Pub. No.: US 2005/0178270 A1
(43) Pub. Date: Aug. 18, 2005

(54) Apparatus for separating gas into gas components using ionization

(76) Inventors: Takao Ito, Saitama (JP); Hitoshi Emi, Ishikawa (JP); Yoshio Otani, Ishikawa (JP); Norikazu Namiki, Ishikawa (JP)

Correspondence Address: OHLANDT, GREELEY, RUGGIERO & PERLE, LLP, ONE LANDMARK SQUARE, 10TH FLOOR, STAMFORD, CT, 06901, US

(21) Appl. No.: 10/509,450

(22) PCT Filed: Mar. 26, 2003
(86) PCT No.: PCT/JP03/03730

(30) Foreign Application Priority Data
Mar. 28, 2002 (JP) 2002-093122
Sep. 4, 2002 (JP) 2002-258991

(51) Int. Cl. B03C 3/68

(52) U.S. Cl. 96/18

(57) ABSTRACT

In an apparatus for ionizing and separating a gas into gas components in an inlet gas (11), a gas flowing into a flow channel of a chamber from an inlet port is ionized, and in the flow channel the gas ionized by applying an electrical field to the gas components having an ionized state by electrodes (16) (17) is separated into a cation and anion to separate a gas molecule component contained in the gas. One of the gas component such as a clean air is removed from a first outlet (12) port and the separated gas component is removed from a second outlet (13) port. A flow of the inlet gas from the inlet port is adjusted to retain the gas in the flow channel of the chamber for a predetermined or more time so that an airflow is adjusted.

### TECHNICAL FIELD

The present invention relates to an apparatus for ionizing an inlet gas and separating the gas into gas components, particularly to a gas ionization/separation apparatus suitable for use as a gas separation apparatus which separate a gas into a purified gas component and other components for use in a process of performing fine processing in a range of a nanometer to micrometer or as an cleaning apparatus for removing a trace amount of molecular components from air.

### BACKGROUND ART

As a method of refining a high-purity hydrogen gas, there is a film transmission type refining method in which the hydrogen gas is passed through a film of a palladium alloy. In the film transmission type refining method, a remarkably high separated gas component is obtained. However, in order to obtain a large amount of the refined high-purity gas, a pressure difference between the gas spaces separated by the film needs to be large at a high temperature. Therefore, the film transmission refining method requires much energy.

As a gas refining method that can be applied to many types of gases, there is an adsorption refining method of adsorbing the gas with an adsorbent. In the adsorption refining method, impurities in the gas can be adsorbed at a normal temperature. The adsorbent adsorbing the impurities can reactivated by treatments such as heating and reproduce adsorbability. When the gas is continuously refined, it is necessary to prepare two or more adsorption columns and alternately operate them in adsorption/desorption mode.

As a gas purifying method of a rare gas such as argon and helium or a hydrogen gas, there is a getter refining method. In the getter refining method, it is necessary to react a getter material with the impurities in the gas at the high temperature. Therefore, the getter refining method requires much energy. The getter material that has once reacted with the impurities cannot be reproduced, and is disadvantageously discarded.

On the other hand, in Jpn. Pat. Appln. KOKAI Publication No. 2001-70743, the present applicant has proposed a method of continuously purifying the gas with low energy. The method comprises: separating the gas into positive and negative ions by an electrical field to purify the gas. This proposed apparatus includes a structure in which parallel plate electrodes with gas outlets are disposed on opposite sides of a chamber to form two branching-flows. In the separation apparatus structured in this manner, a flow branch section is the same as an ion separation region, and the ionized impurities are separated in a minimum ion-migration distance by the electrical field. Even though the ionized impurities, which have once moved from on one branching flow to the other branching flow are neutralized, the impurities can be taken out along the flow. Therefore, the apparatus is superior in refining the gas having a higher purity. However, in the structure of the parallel plate electrodes with the outlets, a stagnant region exits in the vicinities of corners of the chamber. Therefore, with a high flow rate, an introduced gas is not smoothly exhausted, and the separation efficiency of impurities changes with the gas flow rate. Moreover, in the separation, it is necessary to secure a retention time until the impurities are effectively ionized. However, with the aforementioned separator, a short-cut flow of the gas introduced in the separation chamber to the outlet is inevitable. Therefore, it is difficult to secure the retention time even with a secured large diameter of the chamber. Moreover, a separation flow volume needs to be divided into equal volumes. Therefore, a flow meter and valve have to be disposed at the outlet so that the volume is adjusted into the equal volumes. However, the flowmeter cannot be disposed in an inlet of the gas flow or outlets of the branched gases in some case. When the flowmeter cannot be disposed, there is a problem that the flow volume cannot be adjusted.

Moreover, in separating the gas ion into two branches, a separation voltage to be applied has an optimum value which is determined in accordance with the flow rate of the gas, electrical mobility of the ion, and generation and depletion rates of the ion. Here, the electrical mobility and generation/depletion rate of the ion vary with a pressure or temperature of the gas. Therefore, there is a problem that separation efficiency is influenced depending on a state of pressure or temperature.

### DISCLOSURE OF INVENTION

An object of the present invention is to provide an apparatus for ionizing and separating a gas component in an inlet gas, which is low in energy and high in efficiency.

According to an aspect of the present invention, there is provided an apparatus for ionizing and separating a gas into gas components in an inlet gas, comprising:
a chamber structure configured to defining a flowing channel, which has an inlet port and first and second outlet ports;
an ionizer for ionizing gas components in the gas flowing into the flow channel via the inlet port;
means for applying an electrical field to the ionized gas components in the flow channel to separate the gas components into a cation and anion, thereby separating a gas molecule component contained in the gas;
means for extracting one of the gas component from the first outlet port, and extracts the another of the gas component from the second outlet port: and
control means for controlling a flow of the inlet gas from the inlet port and retaining the gas in the flow channel for a predetermined time period and more.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF DRAWINGS

The accompanying drawings, which are incorporated in and constitute a part of the specification, illustrate embodiments of the invention, and together with the general description given above and the detailed description of the embodiments given below, serve to explain the principles of the invention.

FIG. 1 is a perspective view schematically showing a two-branching-flow gas ionization/separation apparatus according to one embodiment of the present invention;

FIG. 2 is a cross-sectional view schematically showing an ionizer shown in FIG. 1;

FIG. 3 is a typical characteristic diagram showing one example of an experiment result obtained by separating a trace amount of oxygen in a high-purity nitrogen gas in a separation apparatus shown in FIG. 1;

FIG. 4 is an explanatory view showing ionization potential and proton affinity of nitrogen, oxygen, and toluene;

FIG. 5 is a cross-sectional view schematically showing a separation electrode shown in FIG. 1;

FIG. 6 is a cross-sectional view schematically showing the gas ionization/separation apparatus according to another embodiment of the present invention;

FIG. 7 is a characteristic diagram showing one example of a result obtained by separating toluene of an organic material by the gas ionization/separation apparatus shown in FIG. 6;

FIG. 8 is a characteristic diagram showing a separation efficiency in the gas ionization/separation apparatus according to the embodiment of the present invention together with a related-art separation efficiency comparative example;

FIG. 9 is a cross-sectional view showing a differential pressure detecting method in adjusting a gas flow volume according to the embodiment of the present invention;

FIG. 10 is a characteristic diagram showing a relation between flow volumes of opposite outlets and pressure difference according to the embodiment of the present invention;

FIG. 11 is an explanatory view showing an arrangement use example of the gas ionization/separation apparatus according to the embodiment of the present invention;

FIG. 12 is a cross-sectional view showing the gas ionization/separation apparatus including a pressure measurement portion which measures the pressure of the gas according to the embodiment of the present invention; and

FIG. 13 is a characteristic diagram showing one example of a result obtained by solving an advective diffusion equation with respect to an molecular component and ion to calculate a separation efficiency in ionizing and electrostatically separating the molecular component in a two-branching-flow field according to the embodiment of the present invention.

### BEST MODE FOR CARRYING OUT THE INVENTION

A gas ionization/separation apparatus according to an embodiment of the present invention will be described hereinafter in detail with reference to the drawings.

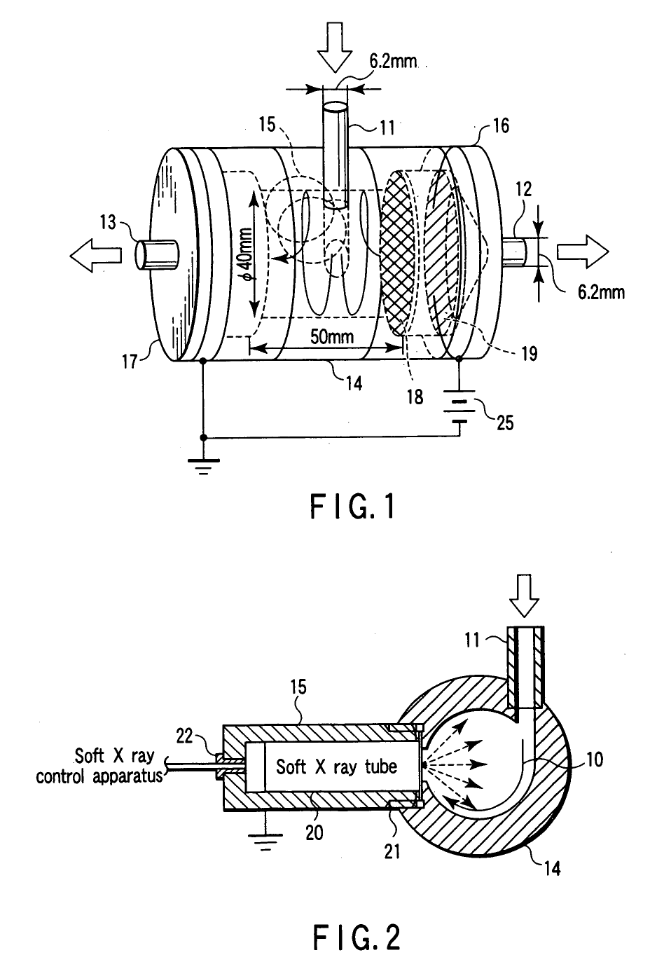

FIG. 1 shows a gas ionization/separation apparatus of two-branching-flow type according to an embodiment of the present invention. In the gas ionization/separation apparatus, generation of an ion and separation of the ion by an electrical field are simultaneously performed, and electrodes for applying the electrical field has a configuration to serve as a gas outlet port. In FIG. 1, reference numeral 11 denotes an inlet port of gas mixture, for example a mixture of air and gas, via which the gas mixture flows into the apparatus, 12, 13 denote gas outlet ports, via which the separated gas component flows out, and 14 denotes a separation chamber in which a flow channel is defined. In the separation chamber 14, an ionizer 15 is disposed to ionize the gas components in the flow channel. Separation electrodes 16, 17 having a structure detachable from the chamber 14 close the chamber 14, and the outlet ports 12, 13 for outputting the gas components are disposed in the separation electrodes 16, 17. The chamber 14 has a porous electrode 18 and glass fiber filter 19 (flow resisting part) formed of porous member in such a manner that the gas component flowing toward the outlet ports 12, 13 pass through the member. The inlet port 11, ionizer 15, separation electrodes 16, 17, and porous electrode 18 are formed of metals such as SUS. For the separation chamber 14, an annular strip-shaped portion including portions connected to the inlet port 11 and ionizer 15 is formed of metals such as SUS, and the other portions are formed of insulating materials such as quartz glass.

The separation chamber 14 is formed in a cylindrical shape, which has an inner diameter of 40 mm, and is provided with a cylindrical flow channel, and disposed substantially horizontally in an axial direction. In left and right openings in opposite ends of the separation chamber 14, the separation electrodes 16, 17 are disposed substantially in parallel with and opposite to each other so as to close the openings of the separation chamber 14. In a middle portion of the separation electrode 16, the first outlet port 12 formed in a cylindrical shape with an inner diameter of 6.2 mm is disposed. In the middle portion of the separation electrode 17, the second outlet port 13 formed in the cylindrical shape with an inner diameter of 6.2 mm is disposed. In the middle portion of an outer peripheral surface of the separation chamber 14, the inlet port 11 formed in the cylindrical shape having an inner diameter of 6.2 mm is disposed to supply the gas in a peripheral direction of the inner surface of the separation chamber 14 and generate a circular flow. Inside the respective separation electrodes 16, 17 in the separation chamber 14, the glass fiber filters (flow resisting parts) 19, 19 are disposed to obstruct the cylindrical flow channel. Inside the respective glass fiber filters 19, 19 in the separation chamber 14, the porous electrodes 18, 18 are disposed to obstruct the cylindrical flow channel. The porous electrodes 18, 18 are disposed opposite to each other at an interval of 50 mm and substantially in parallel with each other. The ionizer 15 is disposed between the porous electrodes 18, 18 in the separation chamber 14. The separation electrodes 16, 17 are connected to a direct-current voltage supply 25 so that the electrode 16 is an anode and the electrode 17 is a cathode.

In this apparatus, the gas components flow to the outlet ports 12, 13 from the inlet port 11 as follows. That is, the gas introduced into the separation chamber 14 flows along a cylindrical flow channel inner surface from a tangential (peripheral) direction. Moreover, the respective gas outlet ports 12, 13 include two types of electrodes charged in the same polarity. That is, the outlet port 12, the electrode 16 and the porous electrode 18, which are located at the side of the outlet port 12, are charged in one polarity, and the outlet port 13, the electrode 17 and the porous electrode 18, which are located at the side of the outlet port 13, are charged in the other polarity. In an inner space of the hollow separation electrode 16 (17), the porous electrode 18 and glass fiber filter (flow resisting part) 19 having a high pressure loss are disposed in series with each other. The gas introduced into the flow channel in the separation chamber 14 passes through the porous electrode 18, and glass fiber filter (flow resisting part) 19 and flows out via the gas outlet port 12 (13). That is, the gas, which is introduced into the flow channel from the side surface middle portion of the cylindrical chamber 14 having an inner diameter of 40 mm, are branched towards two outlet ports 12, 13 disposed opposite to each other and exhausted to the outside of the apparatus via the respective outlets.

The gas is introduced into the separation chamber 14 from the gas inlet port 11, soft X-rays are irradiated to the gas from the ionizer 15 fixed to the separation chamber 14, and the gas components are ionized in the separation chamber 14. Certain molecular gas components, which are regarded as impurity components, are charged as the cations by ion-molecule reaction. Moreover, the introduced gas is controlled so that the gas flows in along the flow channel inner surface of the cylindrical separation chamber 14 from the tangential (peripheral) direction and the flowing gas forms the circular stream in the flow channel. This circular flow prevents the gas flow from forming a short-cut gas stream flowing toward the outlet ports 12, 13 from the inlet port 11. It is possible to secure a long time for which the gas is retained in the flow channel. That is, a soft X-ray irradiation time lengthens with respect to the gas, and the molecular components can sufficiently be ionized. For the respective electrodes (separation electrodes 16, 17 and porous electrodes 18, 18) disposed in two outlet ports 12, 13, a direct-current voltage is applied to dispose one outlet port 12 on an anode side and the other outlet port 13 on a cathode side. An electrical field is formed in the flow channel. The molecular components ionized as the cations move to the outlet port 13 on the cathode side. A high-purity gas component is separated from the gas and is taken from the outlet port 12 on the anode side.

FIG. 2 is a cross-sectional view of FIG. 1. The ionizer 15 has a structure in which a soft X-ray tube 20 is located in a metal vessel such as SUS vessel connected to the ground. For example, the ionizer 15 is fixed to a side surface portion of the separation chamber 14 with a screw 21 from the outside. The soft X-ray tube 20 is applied with a high voltage and is controlled by a soft X-ray control apparatus (not shown), and the soft X-ray tube 20 emits the soft X-rays into the flow channel of the separation chamber 14. It is to be noted that in FIG. 2, reference numeral 22 denotes an insulating material such as a fluorocarbon resin. Moreover, the gas inlet port 11 is devised to allow the gas to flow in along the flow channel inner surface of the separation chamber 14 having the cylindrical shape from the tangential direction, so that the flow stream of the gas introduced into the separation chamber 14 forms a circular flow 10 inside the cylindrical flow channel. By this circular flow, the gas introduced into the separation chamber 14 flows along the inner surface of the cylindrical flow channel, and can be irradiated with a sufficient amount of soft X-rays.

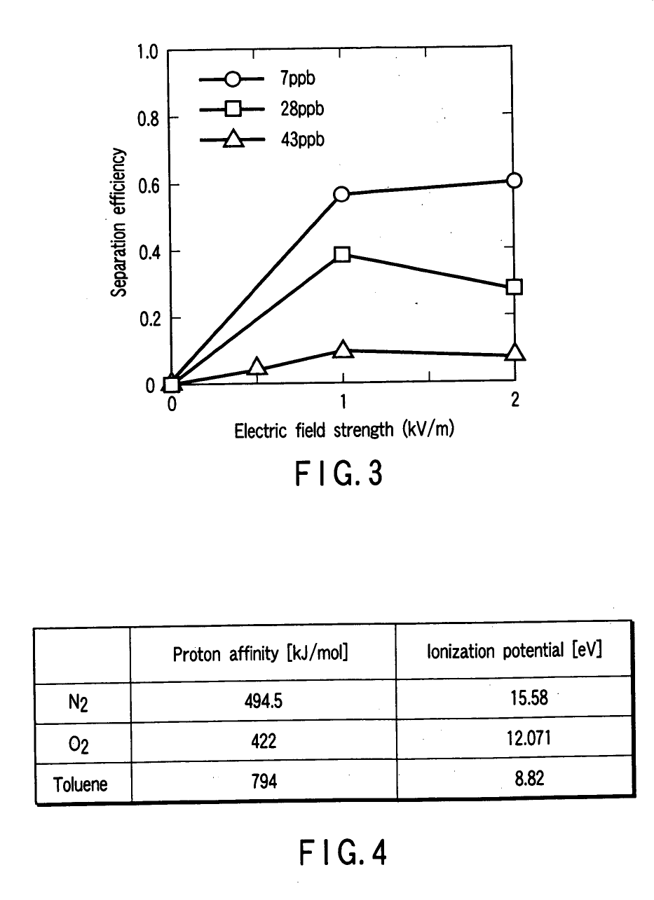

FIG. 3 is a characteristic diagram showing one example of an experiment result obtained by separating a trace amount of oxygen in a high-purity nitrogen gas in a separation apparatus shown in FIG. 1. In the characteristic diagram, the abscissa indicates electrical field strength, and the ordinate indicates the flux of separated oxygen molecules with respect to the flux of inflow oxygen molecules via the inlet, which is separation efficiency. FIG. 3 shows a result of trace oxygen separation from nitrogen gas with inlet concentrations of 7 ppb, 28 ppb, 43 ppb at an inlet flow rate of 1 L/min. The separation efficiency of oxygen increases with a lower concentration. With 7 ppb of oxygen at electrical field strength of 2 kV/m, a maximum separation efficiency of 60% obtained. To preferentially ionize the certain molecular component, ionization energy is requested to be smaller than that of a carrier gas molecule. Alternatively, proton affinity is requested to be larger than that of the carrier gas molecule. FIG. 4 shows ionization potential and proton affinity of nitrogen, oxygen, and toluene. For nitrogen and oxygen, oxygen has a smaller ionization potential and is more easily charged, but a difference of proton affinity is small as compared with organic materials such as toluene, and separation effect is low. However, it is seen that even the oxygen molecule can be separated using the separation apparatus of FIG. 1.

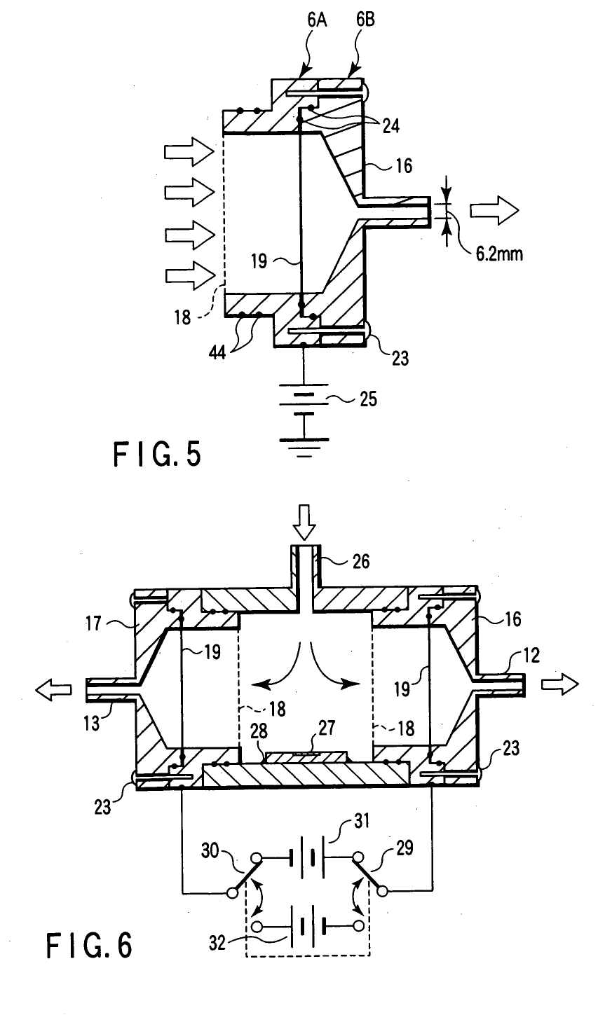

FIG. 5 shows the structure of the separation electrode disposed in the outlet port. The separation electrodes 16, 17 are constituted of hollow electrode portions 6A, 6B formed of metals. The glass fiber filter (flow resisting part) 19 is held between the electrode portions 6A, 6B via O rings 24, and both the electrode portions are fixed with screws 23. Moreover, the separation electrodes 16, 17 are connected to the cylindrical separation chamber 14 via gastight fixing members such as O rings 44. The glass fiber filter 19 may be a micro glass fiber such as a HEPA filter, and any material may be used as long as the material has a fluid resistance uniformly dispersed in the whole flow channel. For advantages of the filter 19 held between the electrode portions 6A, 6B, since the glass fiber filter (flow resisting part) 19 has a micro structure, contaminant such as particles are easily deposited, but the filter can easily be changed because of the disconnectable structure of the electrode portions 6A, 6B. The metal porous electrode 18 is attached to the front surface of the electrode portion 6A, that is, an upstream-side end, and the outer surface of the electrode portion 6A is connected to the direct-current (DC) voltage supply 25. Therefore, not only the separation electrodes 16, 17 but also the porous electrode 18 can simultaneously be charged. When the separation electrodes 16, 17 are not disposed and only the porous electrode 18 is disposed in order to connect between the porous electrode 18 disposed inside and the DC voltage supply from the outside of the cylindrical separation chamber 14, it is necessary to make a hole in the separation chamber 14 and to pass an electrical wire through the hole. However, both the porous electrode 18 and electrode portion 6A are formed of the metals, and attached so as to be integrally molded or united, and thereby the voltage can be applied to the porous electrode 18 by connecting the wire to the electrode portion 6A from the outside. In the porous electrode 18, a fine metal mesh may be used, and any shape or material may be used as long as the electrical fields can be formed in parallel with one another in the separation chamber 14 and the gas can uniformly be exhausted.

It is to be noted that the insulating material of the present apparatus is not limited to quartz glass, and materials such as a ceramic or resin may also be used. Furthermore, a material for connecting the insulating material to the electrode or ionizer is not limited to the O ring, and sheet-shaped materials may also be used such as a metal seal of nickel plated with silver and a silicon rubber.

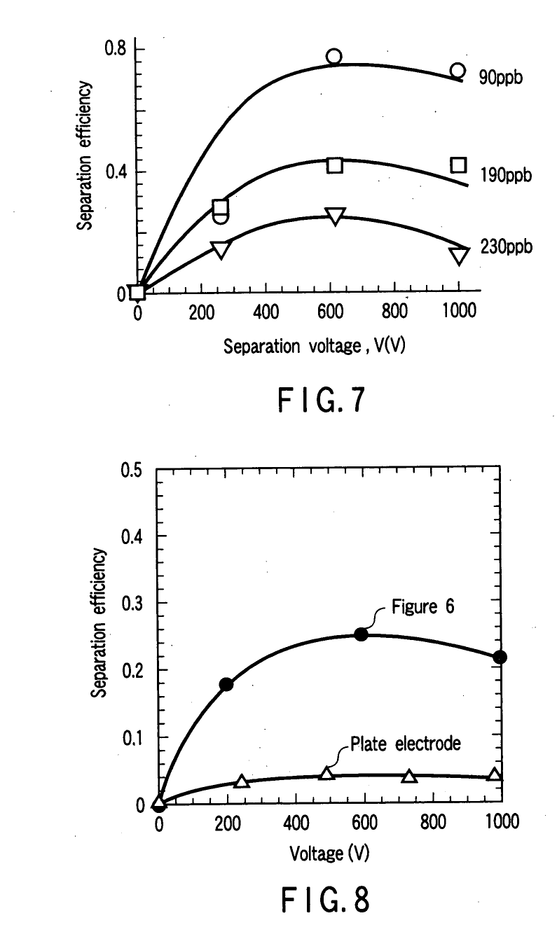

FIG. 6 is a cross-sectional view showing the gas ionization/separation apparatus according to another embodiment of the present invention. As an ion source, a radioactive isotope 241 Am fixed to the cylindrical flow channel inner surface is used. In FIG. 6, the same portions as those of FIG. 1 are denoted with the same reference numerals, and the description thereof is omitted. In an outer peripheral surface middle upper portion of the separation chamber 14, a cylindrical gas inlet port 26 is disposed to open the chamber 14 to the outside. In a middle bottom portion inside the chamber 14, a radiation source 27 such as the radioactive isotope ²⁴¹ Am is disposed opposite to the gas inlet port 26 and fixed with an epoxy resin 28. When the above-described circular flow is not used in the present embodiment, and when the flow volume is large, there is a limitation in the amount of trace gas components, which can be ionized. However, when the glass fiber filters (flow resisting parts) 19 disposed in the inner spaces of the separation electrodes 16, 17 of the outlet ports 12, 13 are used to rectify branching flows, the trace gas component can steadily be ionized and separated. Moreover, the direct-current power supplies 31, 32 by cooperating changeover switches 29, 30, can change the polarities of the electrodes 16, 17. Thereby, a clean air or separated gas can arbitrarily be taken out via either outlet port 12 or 13. It is to be noted that with the use of the radioactive isotope 241 Am and soft X-ray as the ion sources, an ion generation amount in the flow channel can further be increased. Additionally, other ionizer such as an electrical discharge unit can be used alone or combined as the ion source of the present apparatus, as long as the ion can be generated.

FIG. 7 is a characteristic diagram showing one example of a result obtained by separating toluene of the organic compound by the gas ionization/separation apparatus of FIG. 6. The ordinate indicates a toluene flux with respect to an inflow toluene flux via the inlet, which is the separation efficiency, and the abscissa indicates each separation voltage. Toluene was separated with inlet volume concentrations of 90 ppb, 190 ppb, 230 ppb. As a result, with a rise of the applied voltage, the separation efficiency of toluene rises, and the separation efficiency slightly drops with a voltage of 600 V or more. With a lower concentration, the separation efficiency rises. It is also seen that 78% of toluene can be separated with inlet concentration of 90 ppb.

FIG. 8 shows an experimental result obtained by comparing the separation effect of a method using a plate electrode in the electrode of an outlet member in a gas separation apparatus using two branching-flows in the separation chamber according to Jpn. Pat. Appln. KOKAI Publication No. 2001-070743, with that of the method of the gas ionization/separation of FIG. 6. A toluene having a concentration of 0.23 ppm in the nitrogen carrier gas nitrogen was used as a sample to be introduced into the gas inlet port. In FIG. 8, the ordinate indicates the separated toluene flux to the inflow toluene flux via the inlet as the separation efficiency, and the abscissa indicates each separation voltage. It is seen that toluene is hardly separated in any voltage with a flow rate of 2 L/min in the method using the related-art plate electrode. This is because a stagnant region exist in the chamber corner, influence of disturbance of the flow becomes remarkable with a large flow volume, and toluene cannot effectively be separated. However, when the separation electrodes 16, 17 and porous electrodes 18, 18 are used as the electrodes in the outlet ports 12, 13 of FIG. 6, and the glass fiber filters (flow resisting parts) 19 are further disposed, the separation of toluene occurs with the separation voltage. At 600 V, 0.23 ppm of toluene can be separated by 24% at maximum. From this, it is seen that the separation efficiency rises in any separation voltage with the improved structure of the separation electrodes 16, 17 shown in FIG. 5.

It is to be noted that in the present embodiment, the inside of the whole separation chamber 14 is assumed to effectively function as the gas flow channel, a flow channel volume is 62.8 mL (flow channel inner diameter=40 mm, flow channel length=50 mm), an inlet gas flow rate is 2 L/min, and an average retention time of the flow gas in the present apparatus is 1.8 sec. When the flow stream of the gas introduced into the flow channel is controlled so as to form the circular flow in the flow channel under this condition, the average retention time of the inlet gas further lengthens, and a large separation efficiency can be obtained.

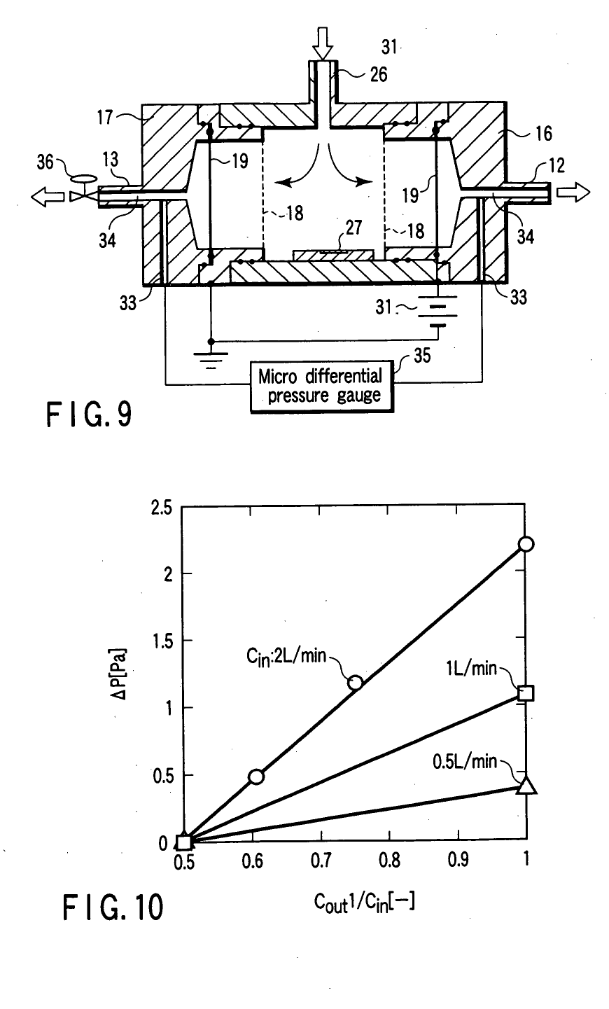

FIG. 9 shows the gas ionization/separation apparatus in which a gas pressure difference between both the outlet ports is detected by a differential pressure gauge to adjust an outlet flow volume. In FIG. 9, the same portions as those of FIG. 6 are denoted with the same reference numerals, and the description thereof is omitted. With the use of the gas flowing out via the anode, in order to easily adjust the outlet flow volume of the present apparatus, holes (diameter of 0.6 mm) are made in the electrodes 16, 17 of the opposite outlet ports 12, 13 until holes 33 reach gas pipes (inner diameter of 6 mm) 34. This method further comprises: measuring the pressure difference between the opposite outlet gases with a differential pressure gauge 35; and opening/closing a flow volume adjustment valve 36 disposed in the outlet port 13 so as to obtain a differential pressure of 0. In this method, without measuring the flow volumes of the inlet port 11 and outlet ports 12, 13 with a flow volume meter, the flow volume of the gas ionization/ separation apparatus can be controlled to obtain a predetermined flow volume. This contributes reduction of an apparatus cost and stabilization of control. It is to be noted that the holes 33 for the differential pressure measurement may be disposed on either upstream or downstream side of the glass fiber filter (flow resisting part) 19, and need to be opened in left and right positions. The values of the flow volume and pressure need to be calibrated beforehand for use.

FIG. 10 shows a result obtained by making the holes 33 each having a diameter of 0.6 mm vertically in the gas pipes (inner diameter of 6 mm) 34 of opposite outlets and checking a relation between a statistic pressure difference and flow volume ratio in the gas pipes 34 of the respective outlets. The abscissa indicates a ratio of a flow volume Cout1 of one outlet 12 with respect to a flow volume Cin of an inlet 26, and the ordinate indicates a result of measurement of a static pressure difference ΔP. It is seen from FIG. 10 that the difference between the outlet flow volumes can be obtained with the static difference ΔP. This is the result of the measurement of the static pressure difference, but a dynamic pressure difference or whole pressure difference may also be measured.

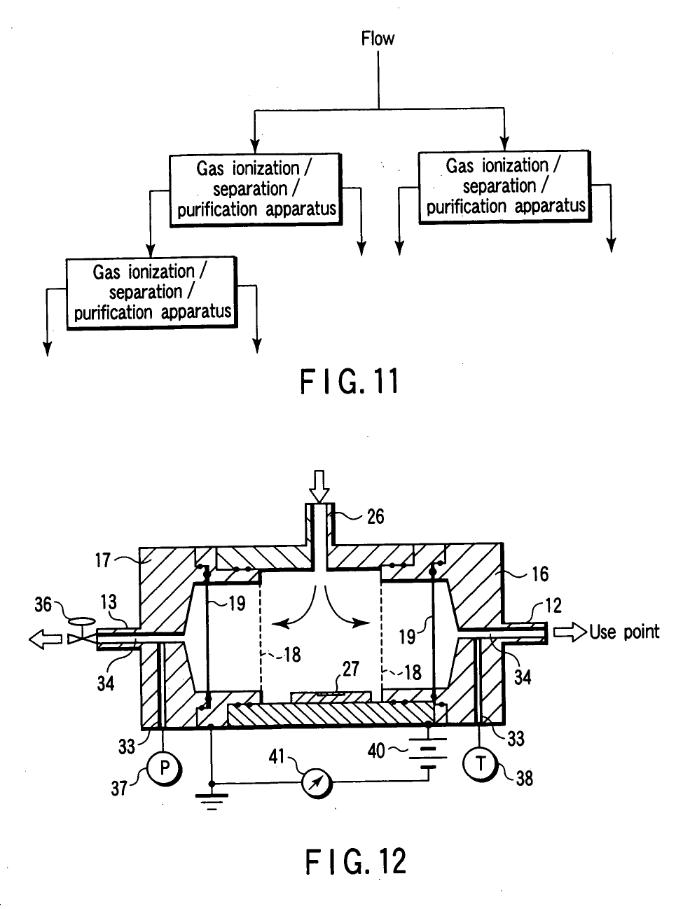

FIG. 11 shows a example in which a large number of gas ionization/separation apparatuses according to the embodiment of the present invention are used in one parallel stage and one series stage. When the apparatuses are arranged in parallel with each other, it is possible to treat the inlet gas with a large flow volume which cannot be compensated with one apparatus. Moreover, when the present apparatuses are disposed in series with each other, a high-efficiency separated gas can be refined. This cannot be achieved with one apparatus.

FIG. 12 shows the gas ionization/separation apparatus including a pressure measurement portion which measures the pressure of the gas and temperature measurement portion which measures the temperature of the gas according to the embodiment of the present invention. In FIG. 12, the same portions as those of FIG. 6 are denoted with the same reference numerals, and the description thereof is omitted. The holes (diameter of 0.6 mm) are made in the separation electrodes 16, 17 of the outlet ports 12, 13 until the holes 33 reach the gas pipes (inner diameter of 6 mm) 34. The pressure of the fluid is measured with a pressure gauge 37, and the temperature is measured with a temperature meter 38. The outlet port 13 includes a flow volume adjustment valve 39. In a circuit which applies the separation voltage, a variable resistor 41 is attached as voltage adjustment means in series with a direct-current voltage supply 40. When the pressure of the fluid in the apparatus rises or the temperature of the flowing gas drops because of pressure resistance of a piping system connected to the apparatus, the variable resistor 41 is adjusted, a larger separation voltage is applied, and thereby the separation efficiency can be prevented from dropping. It is to be noted that the hole 33 to which the pressure gauge 37 or temperature meter 38 is to be attached may be disposed in any position of the apparatus flow channel. The holes may also be made in the flow channel outside the apparatus, as long as the pressure or temperature meter in the apparatus is measured/known. Furthermore, the same hole may be used to dispose the pressure gauge and temperature meters in the same position.

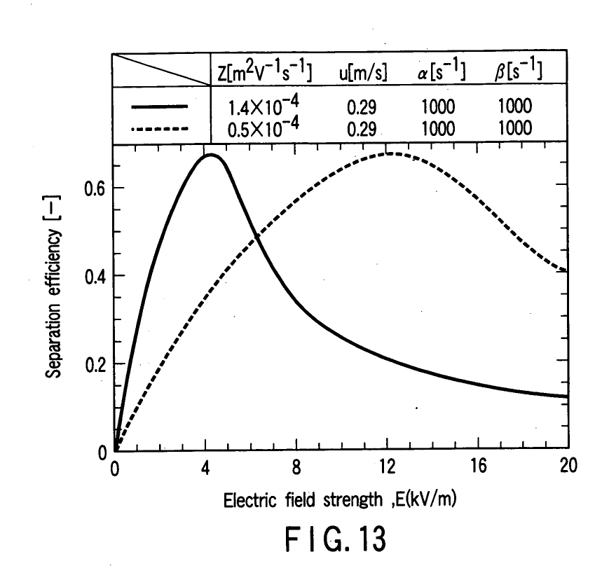

FIG. 13 is a characteristic diagram showing one example of a result obtained by solving an a convective diffusion equation with respect to the molecular component and ion to calculate the separation efficiency in ionizing and electrical migration of trace gas component in a two-branching-flow field. The generation of the toluene ion is defined as a first order reaction in proportion to the concentration of toluene molecules and the depletion of the toluene ion is defined as the first order reaction in proportion to the concentration of toluene ions to perform the calculation. Here, Z denotes an electrical mobility of the ion, u denotes a flow velocity of the gas, α denotes a depletion rate constant of the ion, and β denotes a generation rate constant of the ion. It is seen that an optimum voltage for separating the trace gas component most changes with a change of the electrical mobility of the ion. Parameters such as electrical mobility and rate constant change with the temperature, pressure, or type of the gas. Therefore, in this case, it is seen that an optimum separation voltage is obtained for the pressure or temperature of the gas measured using the pressure gauge 37 or temperature meter 38, the applied voltage is adjusted by voltage adjustment means, and thereby optimum separation can constantly be performed.

It is to be noted that instead of the adjustment of the voltage, the temperature or pressure may also be controlled by temperature or pressure adjustment means disposed, for example, in the inlet 26, or the voltage/temperature/pressure may also be adjusted.

The present invention has been described above based on the embodiments, but is not limited to the embodiments, and can variously be changed without departing from the scope. For example, the flow channel in the separation chamber is not limited to the cylindrical channel. When the flow channel is molded in a tubular shape so as to form the circular flow by the inlet gas inside the channel, a sufficient gas retention time can be secured, and it is possible to effectively generate the ion in the flow channel. Moreover, means for retaining the gas in the flow channel for a predetermined or more time is not limited to a method of forming the circular flow. A method of disposing controlling means such as a baffle plate and guide member in the flow channel and allowing the inlet gas to meander in the flow channel may also be used. At this time, in the structure of the inlet port, the gas does not necessarily have to be introduced along the flow channel inner surface from the tangential direction. Moreover, the direct-current voltage supply for forming the electrical field may be of any type such as a type for applying a positive and/or negative voltage, as long as a predetermined voltage can be applied. Furthermore, the voltage, temperature, or pressure may manually or automatically be controlled. Some of the gas components are charged in the negative ions. When there are a large number of such components, the components may also be separated in the anode.

As described above, in the method of branching the gas introduced from the middle of the separation chamber into two in opposite directions, forming each outlet by the porous separation electrode, and holding the chamber between the electrodes, the stagnation portion of the flow is eliminated. With a high-pressure loss member (HEPA filter) disposed behind the porous member (porous electrode), the gas which has entered the separation chamber is rectified so as to flow along the whole chamber. Furthermore, when the circular flow is formed in the chamber in order to secure the retention time of the gas introduced into the chamber, the retention time for ionizing and separating the ion can be secured. Therefore, there can be provided the gas ionization/separation apparatus, which is high in efficiency and low in energy.

Moreover, when the differential pressure is measured from the static pressure of the gas in each outlet, without measuring the outlet flow volume, the differential pressure can be adjusted, and the flow volume can also be adjusted. When the polarity of the electrode is changed, the separated gas can be taken out via either outlet. Furthermore, with the use of a large number of separation apparatuses of the present invention, a large flow volume which cannot be compensated with one apparatus can be handled. Even the high efficiency separated gas, which cannot be achieved with one apparatus, can be separated.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general invention concept as defined by the appended claims and their equivalents.

1. An apparatus for ionizing and separating a gas into gas components in an inlet gas, comprising:
a chamber structure configured to define a flowing channel, which has an inlet port and first and second outlet ports;
an ionizer for ionizing gas components in the gas flowing into the flow channel via the inlet port;
means for applying an electrical field to the ionized gas components in the flow channel to separate the gas components into a cation and anion, thereby separating gas molecule components contained in the gas;
means for extracting one of the gas components from the first outlet port, and extracting another of the gas components from the second outlet port; and
control means for controlling a flow of the inlet gas from the inlet port and retaining the gas in the flow channel for a predetermined time period and more.

2. The apparatus according to claim 1, wherein the controlling means includes a flow resisting part, which are disposed in each of the first and second outlet ports.

3. The apparatus according to claim 1, wherein the controlling means includes a flow resisting part to allow the gas component to flow out of the flow channel, and applying means includes first and second electrodes disposed in the first and second outlet ports, respectively, and disposed opposite to each other to separate the gas components into a cation and anion so that gas molecule component contained in the gas are separated.

4. The gas ionization/separation apparatus according to claim 3, wherein the first and second outlet ports are provided with first and second porous electrode formed of a porous member as a part of the first and second electrodes, respectively, and the one gas component and the other gas component are passed through the first and second porous electrodes and the flow resisting part, and are extracted from the first and second outlet ports, respectively.

5. The apparatus according to claim 2, wherein the resisting part are detachably provide in front of the outlet ports, respectively.

6. The apparatus according to claim 1, wherein the controlling means allows the gas component to flow in along an inner peripheral surface of the flow channel from the inlet port, and forms a circular flow in the flow channel, so that the inlet gas flow is retained in the flow channel.

7. The apparatus according to claim 1, wherein the flow channel is molded in a cylindrical shape, the inlet port is disposed in a side surface portion of the cylindrical flow channel, and the first and second outlet ports are disposed opposite to each other in opposite ends of the cylindrical flow channel.

8. The apparatus according to according to claim 1, wherein the ionizer includes a plurality of ion sources for ionizing the gas component.

9. The apparatus according to claim 1, wherein the controlling means includes a pressure measurement portion configured to measures a pressure of an outflow gas, and a flow volume adjuster configured to adjust the flow volume of the gases extracted from the respective first and second outlet ports based on a pressure difference between the gas components measured in the first and second outlet ports.

10. The apparatus according to claim 1, further comprising:
means for changing polarity of the electrode which applies the electrical field and means for changing electrical field strength of the electrode.

11. The apparatus according to claim 1, further comprising:
means for changing polarity of the electrode which applies the electrical field.

12. The apparatus according to claim 1, further comprising means for changing electrical field strength of the electrode.

13. apparatus according to claim 1, further comprising: temperature measurement means for measuring a temperature of the gas in the flow channel so that an optimum separation voltage is applied in accordance with the measured gas.

14. The apparatus according to claim 1, further comprising: pressure measurement means for measuring a pressure of the gas as a gas state in the flow channel so that an optimum separation voltage is applied in accordance with the measured gas component.

15. The apparatus according to claim 1, further comprising: temperature measurement means for measuring the temperature of the gas in the flow channel so that the gas state is adjusted to have an optimum temperature in accordance with the applied separation voltage.

16. The apparatus according to claim 1, further comprising: pressure measurement means for measuring the pressure of the gas as a gas state so that the gas state is adjusted to have an optimum pressure in accordance with the applied separation voltage.
